(19) United States
(12) Patent Application Publication
(10) Pub. No.: US 2026/0030356 A1
(43) Pub. Date: Jan. 29, 2026

(54) MANAGING LEVELS OF TRUST FOR COMPONENTS OF DATA PROCESSING SYSTEMS

(71) Applicant: Dell Products L.P., Round Rock, TX (US)

(72) Inventors: DEEPAGANESH PAULRAJ, Bangalore (IN); VINOD PARACKAL SABY, Bangalore (IN)

(21) Appl. No.: 18/785,253

(22) Filed: Jul. 26, 2024

(51) Int. Cl. G06F 21/57; G06F 21/73

(52) U.S. Cl. CPC G06F 21/57; G06F 21/73

(57) ABSTRACT

Methods and systems for managing operation of a data processing system are disclosed. Channel cards of the data processing system may attempt to interact with hardware resources of the data processing system during provisioning of computer-implemented services. The channel cards may be assigned levels of trust based on types of the channel cards. To determine whether a channel card is authorized to interact with a hardware component, a level of trust for the channel card may be obtained. Based on the level of trust, it may be determined whether the channel card is authorized to access the hardware component. If the channel card if authorized to access the hardware component, the attempted interaction may be allowed to occur. If the channel card is not authorized to access the hardware component, the attempted interaction may be denied.

### FIELD

Embodiments disclosed herein relate generally to managing operation of data processing systems. More particularly, embodiments disclosed herein relate to systems and methods to manage levels of trust for components of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating components of a data processing system in accordance with an embodiment.

FIG. 2A shows a data flow diagram illustrating management of interactions between components of a data processing system in accordance with an embodiment.

FIG. 2B shows a data flow diagram illustrating management of levels of trust for components of a data processing system in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services. To provide the computer-implemented services, hardware resources of the data processing system such as memory, processors, channel cards, etc., may operate in cooperation with one another. During cooperative operation, hardware resources may attempt to access information stored by other hardware resources, may attempt to issue commands to other hardware resources, and/or may otherwise attempt to activate functions of other hardware resources.

For example, a channel card of the data processing system may interact with a memory module of the data processing system to facilitate provision of the computer-implemented services. The channel card may include, for example, a graphics card, a sound card, a storage card, and/or other types of hardware components of the data processing system that may be added, removed and/or replaced. As part of providing the computer-implemented services, the channel card may request access to at least a portion of data stored by the memory module.

Over time (e.g., after an end user obtains the data processing system from the manufacturer), stock hardware components (e.g., hardware components added to the data processing system by a manufacturer at the time of manufacturing) of the data processing system may be modified. For example, portions of the stock hardware components may be replaced, added, removed, and/or otherwise modified to improve performance of the data processing system.

For example, a user may replace a stock channel card that was manufactured by the manufacturer of the data processing system with an aftermarket channel card. The aftermarket channel card may include different (e.g., additional) functionality from the stock channel card. For example, the aftermarket channel card may include standard features (e.g., known functionality, based on a current or preceding industry standard with which the replacement channel card is compliant) and non-standard features.

Consequently, the data processing system may be operably connected to a heterogeneous set of channel cards, the heterogeneous set of channel cards including channel cards of different types. Types of channel cards may be assigned based on whether a channel card is manufactured by the manufacturer of the data processing system, whether the channel card is authorized by the manufacturer of the data processing system, and/or based on other criteria. During operation of the data processing system, channel cards of the heterogeneous set of channel cards may interact with hardware components (e.g., stock hardware components) of the data processing system and may attempt to activate functions of the hardware components during the interactions as part of providing computer-implemented services.

However, allowing aftermarket hardware components access to the hardware components of the data processing system may present security concerns, as the aftermarket channel cards may be compromised by a malicious entity and/or may be vulnerable to compromise. Therefore, different types of channel cards of the heterogeneous set of channel cards may have different permissions (e.g., for accessing the hardware resources) to reduce a likelihood of compromise of the hardware resources.

Channel cards added to a data processing system may be typified by a management entity (e.g., a management controller) that operates independently from and is tasked with managing hardware resources of the data processing system. The management controller may identify types of channel cards, may assign levels of trust based on the types of the channel cards, and may provide the levels of trust to a basic input/output system (BIOS) of the data processing system for use during startup.

Therefore, when a channel card attempts to interact with a hardware component of the hardware resources, a level of trust for the channel card may be obtained. Levels of trust may be based on the types of the channel cards. For example, a first type of channel card may be manufactured by the manufacturer of the data processing system and, therefore, may have a first level of trust. Channel cards having the first level of trust may be authorized to activate all functions of the hardware resources.

Based on the level of trust for the channel card, it may be determined whether the interaction is allowed to occur. If the interaction is allowed to occur, computer-implemented services may be provided, at least in part, based on the interaction. If the interaction is not allowed to occur, the interaction may be denied.

Thus, embodiments disclosed herein may address, among others, the technical problem of managing interactions that include aftermarket modified portions of hardware resources of data processing systems. By managing the interactions automatically and locally (e.g., without user intervention, using out-of-band components of the data processing systems), the data processing systems may be more likely to provide the desired computer-implemented services in a secure manner.

In an embodiment, a method for managing operation of a data processing system is provided. The method may include: making an identification that a channel card of the data processing system has attempted an interaction with a hardware component of hardware resources of the data processing system; in response to the identification: obtaining, using a channel card trust table, a level of trust for the channel card, the level of trust being based, at least in part, on a type of the channel card; making a determination, based on the level of trust, regarding whether the channel card is authorized to interact with the hardware component; in a first instance of the determination in which the channel card is authorized to interact with the hardware component: allowing the attempted interaction to occur, wherein the interaction facilitates provisioning of a computer-implemented service; and in a second instance of the determination in which the channel card is not authorized to interact with the hardware component: denying the attempted interaction.

The method may also include: prior to making the identification: typifying, by a management controller of the data processing system, the channel card to obtain the type of the channel card; assigning, by the management controller and based on the type of the channel card and a schema for assigning levels of trust, the level of trust for the channel card; populating, by the management controller and using the level of trust, the channel card trust table, the channel card trust table indicating levels of trust for each channel card of the data processing system; providing, by the management controller, the channel card trust table to a basic input/output system (BIOS) of the data processing system; and publishing, by the BIOS, the channel card trust table during a startup procedure for the data processing system so that the channel card trust table is usable by an operating system of the data processing system during operation of the data processing system.

The type of the channel card may include one selected from a list consisting of: a first type of channel card that is constructed by a manufacturer of the data processing system; a second type of channel card that authorized by the manufacturer but is not constructed by the manufacturer; and a third type of channel card that is not authorized by the manufacturer.

The channel card trust table may include a list of channel cards of the data processing system and levels of trust for each channel card of the list of the channel cards, the levels of trust indicating different degrees of authorization for accessing the hardware resources, and the channel card being one of the channel cards.

The levels of trust for each channel card of the list of channel cards may be based on associations between different types of channel cards and different levels of trust.

The first type of channel card may have a higher degree of authorization for accessing the hardware resources than the second type of the channel card.

The first type of channel card may have a first degree of authorization for accessing the hardware resources that allows activation of all functions of the hardware resources, the second type of channel card may have a second degree of authorization for accessing the hardware resources that allows activation of a portion of functions of a portion of the hardware resources, and the third type of channel card may have a third degree of authorization for accessing the hardware resources that allows no activation of functions of the hardware resources.

The levels of trust may be assigned by a management controller of the data processing system and provided, by the management controller, to a basic input/output system (BIOS) of the data processing system prior to a startup procedure for the data processing system.

The data processing system may include the management controller separate from and tasked with managing operation of the hardware resources and the channel cards.

A non-transitory media may include instructions that when executed by a processor cause the computer-implemented method to be performed.

A data processing system may include the non-transitory media and a processor, and may perform the computer-implemented method when the computer instructions are executed by the processor.

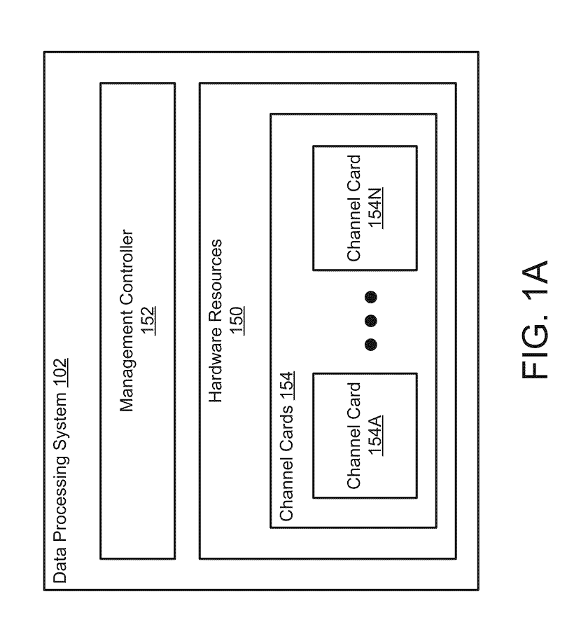

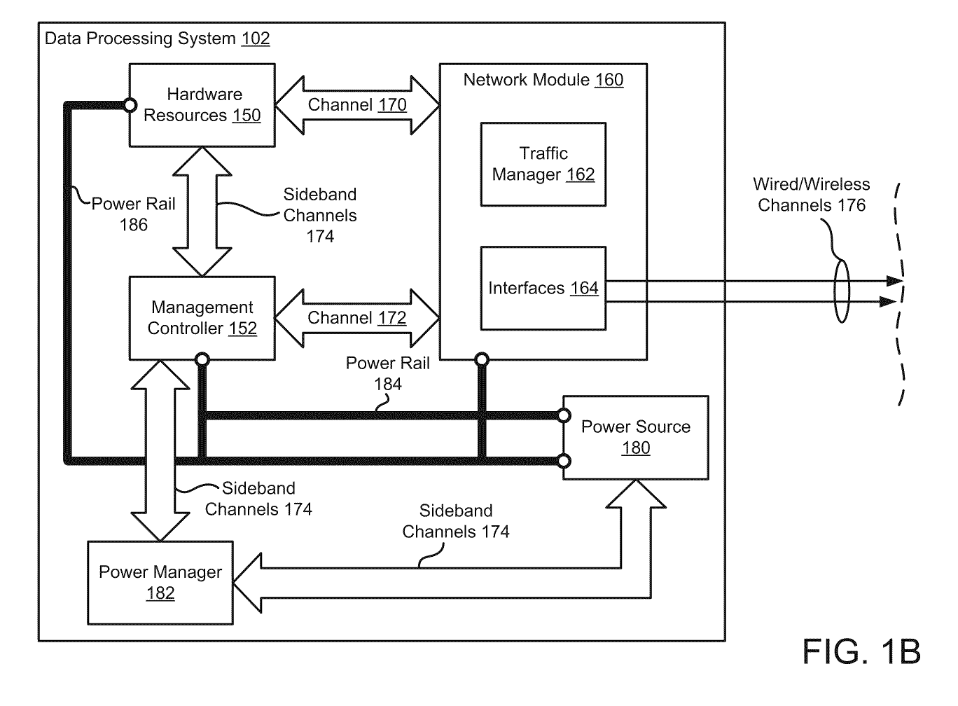

Turning to FIG. 1A, a block diagram illustrating a system in accordance with an embodiment is shown. The system shown in FIG. 1A may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using various components of hardware resources of the data processing system, such as channel cards (e.g., graphics cards, network interface cards (NICs), accelerator cards, expansion cards).

To provide the computer-implemented services, hardware components of the system (e.g., a data processing system) may interact with one another cooperatively. For example, the computer-implemented services may require cooperative interaction between processors, memory modules, storage devices, and/or the channel cards. Based on these interactions, the hardware components may support execution of any number and/or types of software components (e.g., applications hosted by the hardware components), and, in some combination, the hardware and software components may provide for various types of computer-implemented services.

The interactions between the hardware and/or software components may include activation of functions of various hardware components. For example, a channel card may issue a request and/or command to a hardware component (e.g., a memory module) to activate a function of the hardware component (e.g., requesting access to a portion of data stored by the memory module).

Over time (e.g., after manufacturing or setup), hardware components such as channel cards may be modified (e.g., by an end user). For example, a stock channel card may be replaced with an aftermarket channel card, and/or aftermarket channel cards may be added to the data processing system. Functionality of the aftermarket channel cards may vary to a high degree depending on their vendor (e.g., manufacturer of the channel card) and/or due to the programmable nature of some channel cards (e.g., SmartNICs, data processing unit (DPU) cards, etc.).

For example, channel cards may include programmable platform devices capable of performing various functions in various different ways and/or some may require special methods of communication (e.g., specialized application programming interfaces (APIs)). In other words, some functionality or features of the channel cards may (i) not adhere to an industry standard for similar types of channel cards, (ii) may be in addition to the functionality specified by the industry standard, and/or may otherwise require specialized or unusual information to utilize such functions/features. These functions or features may be referred to as non-standard features.

Therefore, the stock hardware components (e.g., hardware components added by the manufacturer during manufacturing and that may only include capabilities to natively interacts with industry standard functionalities/features) may interact with a heterogeneous set of channel cards during operation of the data processing system and, therefore, during provisioning of computer-implemented services.

The heterogeneous set of channel cards may include different types of channel cards. For example, a first type of channel card may be constructed by the manufacturer of the data processing system (e.g., a stock channel card, a replacement stock channel card), a second type of channel card may be authorized by the manufacturer but not constructed by the manufacturer, and a third type of channel card may be neither constructed nor authorized by the manufacturer.

However, different types of channel cards may present varying degrees of security risk (e.g., due to the non-standard features/functionalities that may be present). For example, the third type of channel card may present a higher degree of security risk than the first type of channel card. Some types of channel cards may present a higher degree of security risk due to, for example, an increased likelihood that the channel card may host malicious software and/or may be vulnerable to compromise by a malicious entity. Compromise of the channel card may lead to compromise of the other hardware components and/or other in-band components of the data processing system if the compromised channel card is able to access the hardware resources and/or otherwise interact with other hardware resources.

In general, embodiments disclosed herein may provide methods, systems, and/or devices for managing operation of data processing systems in a manner that increases a likelihood of providing the computer-implemented services as desired by a downstream consumer of the computer-implemented services. To do so, attempts to interact with hardware components by channel cards may be managed based on levels of trust for the channel cards.

Each channel card of the data processing system may be associated with a level of trust, and, in aggregate, the levels of trust may be stored in a channel card trust table accessible by a management entity for the data processing system (e.g., a management controller).

If a channel card attempts to interact with a hardware component, a level of trust for the channel card may be obtained and it may be determined whether the channel card has authorization to perform the attempted interaction based on the level of trust. If the channel card is authorized to interact with the hardware component, the attempted interaction may be allowed to occur and, therefore, facilitate provisioning of the computer-implemented services. If the channel card is not authorized to interact with the hardware component, the attempted interaction may be denied. Denying such interactions may reduce and/or eliminate security threats presented by channel cards. Consequently, host systems may, in turn, also be less likely to become compromised due to activity of the hosted channel cards.

The level of trust in a channel card may be based, for example, on a level of regulation and/or control over a channel card that a manufacturer of the host system may have with respect to the channel card. Higher degrees of regulation and control (e.g., channel card also manufactured by the manufacturer of the host system) over channel cards may allow the manufacturer to mitigate the threats presented by the configurable and/or non-standard capabilities of channel cards, while lower degrees of regulation and control (e.g., channel card manufactured by independent, different manufacturer) over channel cards may prevent the manufacturer or otherwise limit the manufacturer of the host system to mitigate the threats presented by the configurable and/or non-standard capabilities of channel cards. Thus, by basing the levels of trust on regulation and/or control, a balanced approach to limiting risk while mitigating impact on capabilities of channel cards may be provided.

To provide the above-mentioned functionality, data processing system 102 may include hardware resources 150 and/or management controller 152. Data processing system 102, any components thereof and/or any other types of devices or components not shown in FIG. 1A may perform all, or a portion of the computer-implemented services independently and/or cooperatively. Each of these components is discussed below.

Hardware resources 150 may include any number of hardware components (e.g., memory, processors, channel cards). For example, hardware resources 150 may include any number of channel cards 154 (e.g., 154A-154N). Channel cards 154 may include expansion cards and/or adapter cards that may add specific functions or features to data processing system 102. Each channel card of channel cards 154 may be designed to perform a specific task and/or provide additional capabilities to data processing system 102 (e.g., beyond what other hardware components such as a motherboard of data processing system 102 may offer). For example, channel cards 154 may include graphics processing units (GPUs), network interface cards (NICs), storage controller cards, wireless network cards, Universal Serial Bus (USB) expansion cards, and/or other types of cards.

Channel cards 154 may include any number of stock channel cards (e.g., installed by a manufacturer of data processing system 102) and/or aftermarket channel cards (e.g., added by a user of data processing system 102) and, therefore, may include a heterogeneous set of channel cards. Channel cards 154 may function in cooperation with other components of hardware resources 150.

Hardware resources 150 may host applications and/or other software, and store and/or execute instructions provided by the applications and/or the software in order to facilitate provision of a computer-implemented service. For example, an operating system hosted by hardware resources 150 may manage interactions between channel cards and other hardware components (e.g., processors, storage devices, memory modules, etc., not shown) of hardware resources 150.

To do so, the operating system (or other software) may: (i) identify that a channel card of the data processing system has attempted an interaction with a hardware component of the hardware resources, (ii) obtain, using a channel card trust table, a level of trust for the channel card, and/or (iii) determine, based on the level of trust, whether the channel card is authorized to interact with the hardware component. If it is determined that the channel card is authorized to interact with the hardware component, the operating system may allow the attempted interaction to occur. If it is determined that the channel card is not authorized to interact with the hardware component, the attempted interaction may be denied.

By doing so, hardware components of the data processing system may be more likely to be protected from compromise and, therefore, the computer-implemented services may be more likely to be provided as desired.

Management controller 152 may be separate from and tasked with managing operation of hardware components 150 and channel cards 154. For example, upon addition of a channel card (e.g., 154A) to data processing system 102, management controller 152 may: (i) typify the channel card to obtain a type of the channel card, (ii) assign, based on the type of the channel card and a schema for assigning levels of trust, a level of trust for the channel card, (iii) populate, using the level of trust, the channel card trust table, (iv) provide the channel card trust table to a basic input/output system (BIOS) of the data processing system (not shown), and/or (v) perform other actions. By doing so, all channel cards added to data processing system 102 may be assigned levels of trust and, therefore, may have different degrees of authorization to access hardware resources 150. By limiting permissions for channel cards that are not authorized and/or are not manufactured by the manufacturer of data processing system 102, a likelihood of compromise of hardware resources 150 may be reduced.

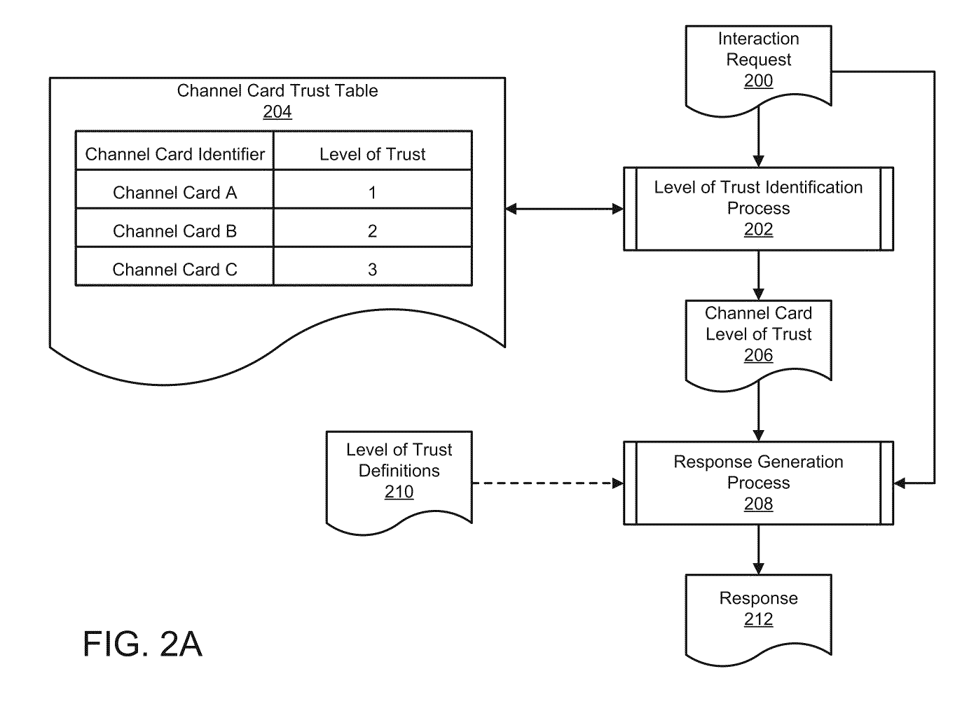

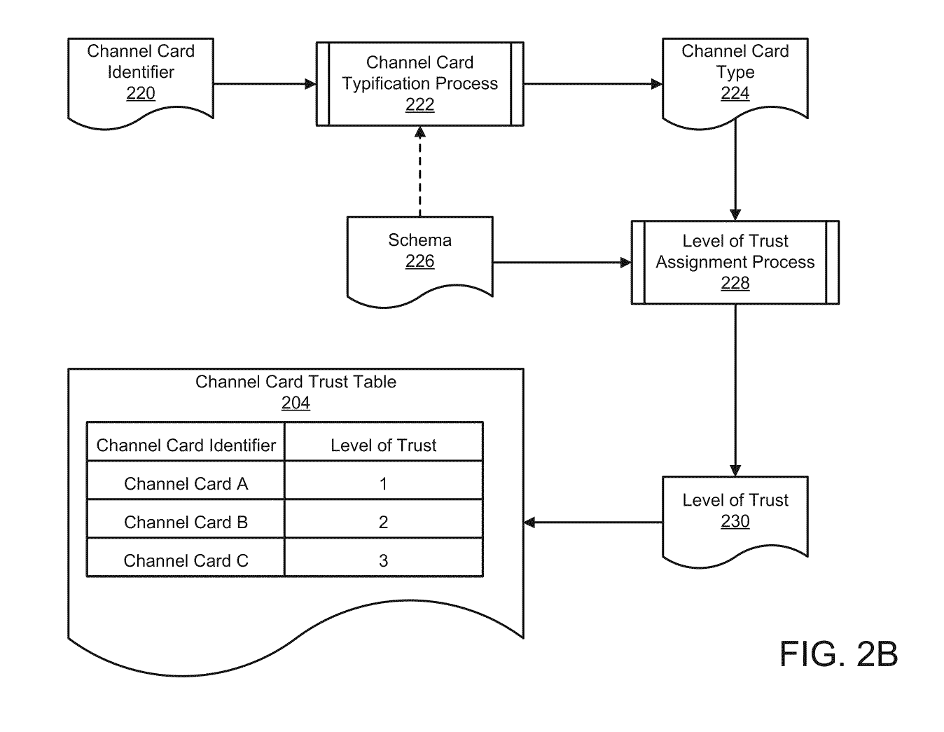

The BIOS (e.g., firmware installed on data processing system 102) may publish the channel card trust table during a startup procedure for data processing system 102 so that the channel card trust table is usable by the operating system during operation of data processing system 102. Refer to FIG. 2B for additional details regarding populating and publishing the channel card trust table.

Management controller 152 may be distinct from and/or may operate independently from hardware resources 150. To facilitate cooperation between hardware resources 150 and management controller 152, hardware resources 150 may host an agent for management controller 152 (not shown). The agent (e.g., a software program) may facilitate communication between management controller 152 and hardware resources 150. As the channel card trust table is populated and managed by management controller 152 (rather than in-band components of data processing system 102), a likelihood that a malicious entity may modify levels of trust for channel cards may be reduced. Refer to the discussion of FIG. 1B for more information regarding the functionality of management controller 152.

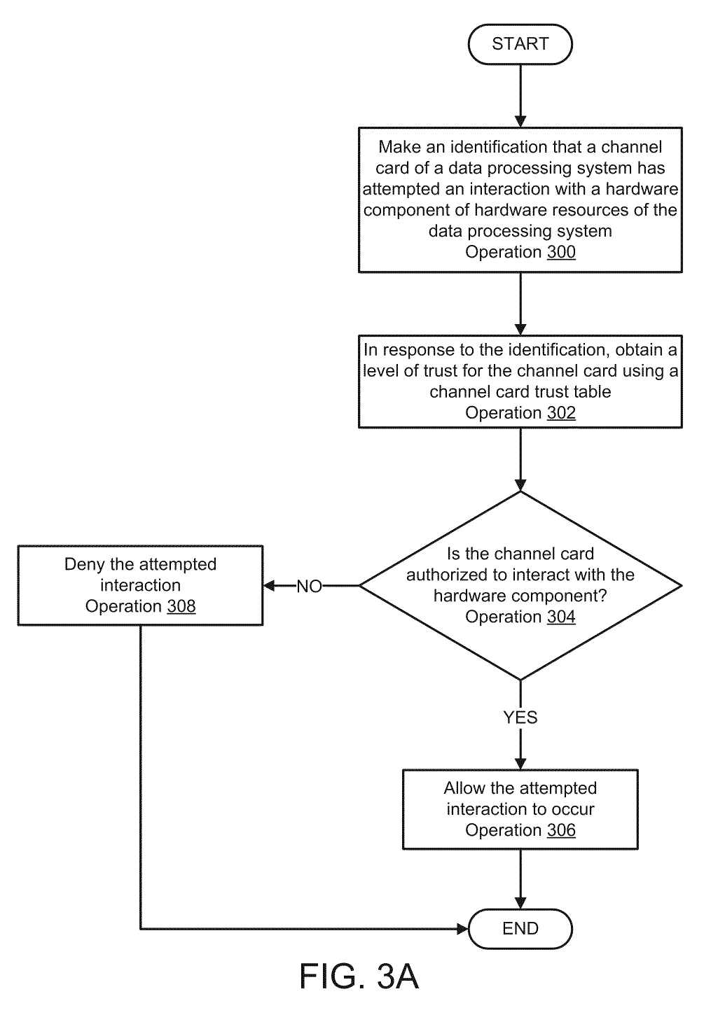

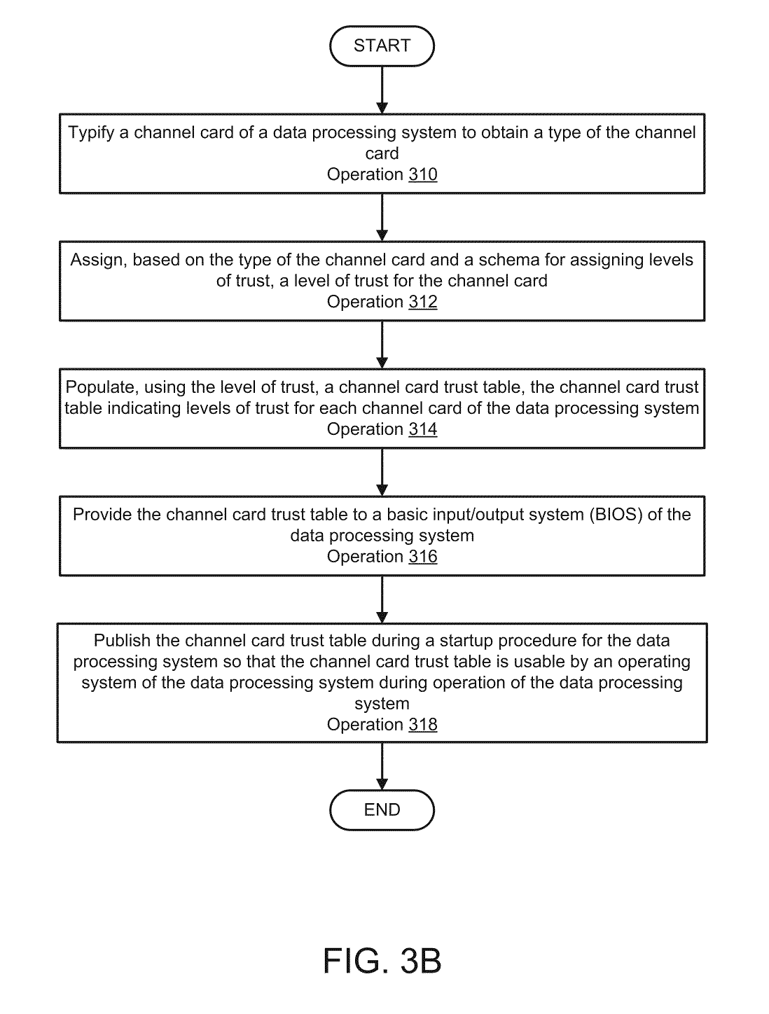

When providing their functionality, any components of data processing system 102 may perform all, or a portion of the actions and methods illustrated in FIGS. 2A-3B.

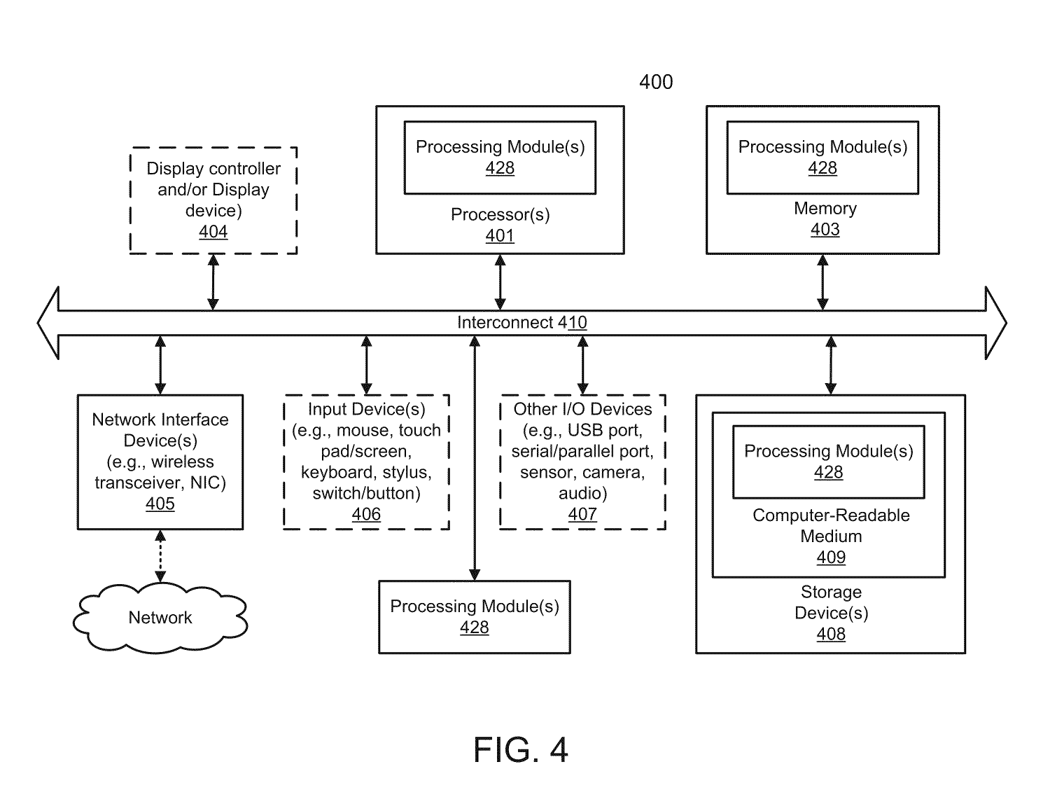

Data processing system 102 (and/or components thereof) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

While illustrated in FIG. 1A as including a limited number of specific components, a system in accordance with an embodiment may include fewer, additional, and/or different components than those illustrated therein.

Turning to FIG. 1B, a diagram illustrating components of a data processing system in accordance with an embodiment is shown. The components of the data processing system shown in FIG. 1B may be similar to those of the system shown in FIG. 1A.

To provide computer-implemented services, data processing system 102 may include any quantity of hardware resources 150. Hardware resources 150 may be in-band hardware components, and may include a processor operably coupled to memory, storage, channel cards, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150, of a host data processing system 102). Management controller 152 may provide various management functionalities for data processing system 102. For example, management controller 152 may monitor various ongoing processes performed by the in-band components, may manage power distribution, may participate in thermal management, and/or other may perform other functions, such as managing security protocols for interactions between channel cards and hardware components of hardware resources 150.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, sideband channels 174 may facilitate communications between management controller 152 and hardware resources 150 so that management controller 152 may identify stock and/or aftermarket channel cards added to data processing system 102. Management controller 152 may typify each channel card based on a manufacturer of the channel card, whether the channel card is authorized by the manufacturer of data processing system 102, and/or based on other criteria. Management controller 152 may assign, using a schema for assigning levels of trust, a level of trust for each channel card and may populate a channel card trust table using the assigned levels of trust. Refer to FIG. 2B for additional details regarding assigning levels of trust to channel cards and populating the channel card trust table.

The populated channel card trust table may be provided, by management controller 152, to a BIOS of data processing system 102 (not shown). By doing so, the BIOS may publish the channel card trust table during a startup procedure for the data processing system thereby making the channel card trust table available for use by management entities (e.g., an operating system) during operation of data processing system 102. The published channel card trust table (not shown) may be used to determine whether interactions between channel cards and hardware components of hardware resources 150 may be allowed to occur. Refer to FIG. 2A for additional details regarding use of the published channel card trust table.

To reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172) from the in-band components, and may implement or otherwise utilize a distinct and independent network stack (e.g., TCP/IP). Consequently, management controller 152 may communicate with other devices independently of any portion of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a Wi-Fi card, a wireless local area network card, a wired local area network card, an optical communication card, and/or other types of communication components. These components may support any number of wired/wireless channels 176.

Thus, from the perspective of an external device, the in-band components and the out-of-band components of data processing system 102 may appear to be two independent network entities, that may independently addressable, and otherwise unrelated to one another.

To facilitate management of data processing system 102 over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, and power may be supplied via the power rails. Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 206, etc.) is used to represent data structures and a second set of shapes (e.g., 202, 208, etc.) is used to represent processes performed using and/or that generate data.

Turning to FIG. 2A, a first data flow diagram in accordance with an embodiment is shown. The first data flow diagram may illustrate data used in and data processing performed in managing interactions between components of a data processing system.

Consider a scenario in which a channel card of a data processing system attempts to interact with a hardware component of the hardware resources of the data processing system. For example, the channel card may attempt to access a portion of data stored by a memory module of the data processing system. To do so, the channel card may provide a request to activate a function of the memory module that allows for the channel card to access the portion of the data, etc.

To attempt to interact with the hardware component, the channel card may generate interaction request 200. The channel card may attempt to provide interaction request 200 (e.g., via an in-band channel of the data processing system) to the hardware component and/or to an intermediary hardware component responsible for managing interactions between channel cards and hardware components. For example, the intermediary hardware component may be a processor of the data processing system that hosts an operating system (e.g., a management entity). The operating system, therefore, may receive and/or intercept interaction request 200.

Interaction request 200 may include: (i) an identifier for the channel card, (ii) an identifier for the desired recipient of interaction request 200 (e.g., the hardware component), (iii) instructions for execution by the hardware component to activate the desired function of the hardware component, (iv) a timestamp for the interaction request, and/or (v) other data.

The operating system may obtain and/or intercept interaction requests from channel cards to determine whether the channel cards are authorized to perform the requested interactions. Therefore, to determine whether the channel card is authorized to interact with the hardware component, the operating system may perform level of trust identification process 202.

During level of trust identification process 202, the identifier for the channel card may be extracted from interaction request 200 and used to search channel card trust table 204 for a level of trust associated with the channel card. Channel card trust table 204 may be stored by the data processing system and may include any number of levels of trust corresponding to channel cards of the data processing system. Channel card trust table 204 may be organized as a series of columns and rows as shown in FIG. 2A with a first column including channel card identifiers and a second column including levels of trust corresponding to the channel cards indicated by the first column.

The channel card identifiers included in the first column may be represented in any manner including, for example, a letter, number, character, and/or combination of the letters numbers and characters to represent a particular channel card.

Similarly, levels of trust included in the second column may be represented in any manner including, for example, numbers, letters, characters, and/or combinations of numbers, letters, and characters.

The levels of trust assigned to each channel card may be based associations between different types of channel cards and different levels of trust. For example, a first type of channel card may be a channel card that is constructed by a manufacturer of the data processing system, a second type of channel card may be a channel card that is authorized by the manufacturer of the data processing system but is not constructed by the manufacturer, and a third type of channel card may be a channel card that is not authorized by the manufacturer. Refer to FIG. 2B for additional details regarding assigning types of channel cards and levels of trust for channel cards.

Channel card trust table 204 may also include a key for the table indicating descriptions for each level of trust of the levels of trust. For example, each level of trust may be associated with a degree of authorization (e.g., level of authority and control that a manufacturer of a host system had over construction/development of a hosted channel card) for accessing the hardware resources of the data processing system.

For example, channel card A may be the first type of channel card. The first type of channel card may be keyed to a level of trust of 1 and, therefore, channel card A may be assigned a level of trust of 1. The key for the table may indicate that the level of trust of 1 indicates that channel card A has a first degree of authorization for accessing the hardware resources that allows activation of all functions of the hardware resources by the channel card. Channel card A may, therefore, be a channel card manufactured by the manufacturer of the data processing system (e.g., may be a stock channel card).

In addition, channel card B may be the second type of channel card. The second type of channel card may be keyed to a level of trust of 2 and, therefore, channel card B may be assigned a level of trust of 2. The key for the table may indicate that the level of trust of 2 indicates that channel card B has a second degree of authorization for accessing the hardware resources that allows activation of a portion of functions of a portion of the hardware resources by the channel card. Channel card B may, therefore, be a channel card manufactured by a third-party manufacturer (e.g., a manufacturer that is not the manufacturer of the data processing system).

However, as the manufacturer of the data processing system has authorized the second type of channel card for use in the data processing system, channel card B may be manufactured by a third-party manufacturer that is known and/or trusted by the manufacturer of the data processing system. Consequently, channel card B may be authorized to activate functions of hardware resources that are considered less likely to expose the data processing system to compromise and may not be authorized to activate functions of the hardware resources that are considered more likely to expose the data processing system to compromise. A likelihood of exposure to compromise for different functions of the hardware resources may be determined by any entity and may be based on any criteria (e.g., to meet needs of a downstream consumer).

In addition, channel card C may be the third type of channel card. The third type of channel card may be keyed to a level of trust of 3 and, therefore, channel card C may be assigned a level of trust of 3. The key for the table may indicate that the level of trust of 3 indicates that channel card C has a third degree of authorization for accessing the hardware resources that allows no activation of functions of the hardware resources by the channel card. Channel card C may, therefore, be a channel card manufactured by a third-party manufacturer (e.g., a manufacturer that is not the manufacturer of the data processing system).

However, the third type of channel card may not be authorized by the manufacturer of the data processing system and, therefore, the manufacturer may have no knowledge and/or may not trust the third-party manufacturer of channel card C. Consequently, channel card C may not be allowed to activate any functions of the hardware resources, as channel card C may be compromised and/or may be vulnerable to compromise by malicious entities.

Therefore, the first type of channel card (e.g., channel card A) may have a higher degree of authorization for accessing the hardware resources than the second type of channel card (e.g., channel card B). In addition, the second type of channel card may have a higher degree of authorization for accessing the hardware resources than the third type of channel card (e.g., channel card C).

For example, the first type of channel card may be authorized to access all data stored by a memory module, the second type of channel card may be authorized to access a portion of data stored by a memory module, and the third type of channel card may not be authorized to access any data stored by the memory module.

Levels of trust may be assigned and/or represented via other methods and may be keyed to different degrees of authorization for accessing the hardware resources without departing from embodiments disclosed herein. Further, the specific information content of channel card trust table 204 may include additional, different, and/or less information. For example, rather than including quantifications for levels, the table may include information on which the levels are based.

Further, it will be appreciated that the trust table may include additional information to further facilitate more granular decision making with respect to channel cards. For example, each channel card may be given multiple levels of trust associated with different types of hardware components. Such multiple levels may allow for different types of interaction limits. In an example, a first type of third party developed channel card may be given a low level of trust for storage devices but a moderate level of trust for communication devices and a second type of third party developed channel card may be given a low level of trust for storage devices and a low level of trust for communication devices. Thus, channel cards having similar levels of management and control by a manufacturer may be given different levels of trust with respect to different types of other hardware components. Accordingly, while the first type of third party developed channel card may be allowed to communicate externally, the second type of third party developed channel card may be prevented from communicating externally. This approach may allow the type of channel card in addition to level of control by a host device manufacturer to be taken into account.

Therefore, during level of trust identification process 202, the operating system of the data processing system may utilize the channel card identifier extracted from interaction request 200 as a key for channel card trust table 204 to perform a lookup process to obtain channel card level of trust 206.

For example, if interaction request 200 indicates that the channel card has a channel card identifier of “channel card B,” then channel card level of trust 206 may indicate that the channel card has an associated level of trust of “2.”

Channel card level of trust 206 may, therefore, include the level of trust for the channel card and/or any other information. Channel card level of trust 206 may be used during response generation process 208 to determine whether interaction request 200 is to be approved.

During response generation process 208, it may be determined whether the channel card is authorized to activate the function of the hardware resource indicated by interaction request 200. To do so, level of trust definitions 210 may be utilized. Level of trust definitions 210 may include descriptions of each level of trust (e.g., 1, 2, 3) indicating the degree of authorization of access corresponding to each level of trust. Levels of trust definitions 210 may include lists of hardware components and/or functions of hardware components authorized for each level of trust, etc. At least a portion of the information included in level of trust definitions 210 may be included in channel card level of trust 206 and, therefore, level of trust definitions 210 may not be required to perform response generation process 208 (as indicated by the dashed line).

During response generation process 208, response 212 may be generated. If the requested function (e.g., indicated by interaction request 200) matches an authorized function for the level of trust assigned to the channel card, response 212 may include an indication that the attempted interaction is to be allowed to proceed. If the requested function does not match an authorized function for the level of trust assigned to the channel card, response 212 may include an indication that the attempted interaction is to be denied.

Response 212 may be provided to the channel card and/or to another entity responsible for allowing and/or denying the attempted interaction.

By doing so, a likelihood of compromise of the hardware resources may be reduced by limiting access to the hardware resources based on levels of trust for channel cards. Consequently, channel cards that have a higher likelihood of being compromised may have a lower degree of access to the hardware resources than channel cards that have a lower likelihood of being compromised.

Turning to FIG. 2B, a second data flow diagram in accordance with an embodiment is shown. The second data flow diagram may illustrate data used in and data processing performed in managing levels of trust for components of a data processing system.

Consider a scenario in which a channel card is added (e.g., operably connected) to the data processing system. A management controller of the data processing system may identify that the channel card has been added and may obtain channel card identifier 220 from the channel card. The channel card may be prompted by the management controller (e.g., via a sideband channel of the data processing system) and/or another entity to provide channel card identifier 220 to the management controller. Channel card identifier 220 may include, for example, a manufacturer of the channel card, a serial number for the channel card, and/or other identifying information for the channel card.

The management controller may be responsible for assigning levels of trust to channel cards. The levels of trust may be usable by an operating system of the data processing system to manage interactions between the channel cards and hardware components of the hardware resources (as described in FIG. 2A). To do so, the management controller may perform channel card typification process 222 using at least channel card identifier 220. During channel card typification process 222, the management controller may identify, based on information included in channel card identifier 220, channel card type 224 for the channel card.

During channel card typification process 222, the management controller may compare the manufacturer of the channel card, the serial number for the channel card, and/or other information for the channel card to types of channel cards as indicated by a schema (e.g., schema 226 and/or another schema). The line between schema 226 and channel card typification process 222 is shown as dashed to indicate that schema 226 may or may not be used during channel card typification process 222. The schema may include a rule set, table, and/or other data structure usable to assign types of channel cards.

For example, channel card identifier 220 may include information indicating that the channel card is manufactured by a manufacturer of the data processing system. The schema may indicate that if the channel card is manufactured by the manufacturer of the data processing system, the channel card is a first type of channel card.

In a second example, channel card identifier 220 may include information indicating that the channel card is manufactured by a vendor that is not the manufacturer of the data processing system. However, the serial number and manufacturer may be listed by the schema as authorized by the manufacturer of the data processing system and, therefore, the channel card may be a second type of channel card.

In a third example, channel card identifier 220 may include information indicating that channel card is manufactured by a vendor that is not the manufacturer of the data processing system. The serial and vendor may not be included in a list of authorized vendors and, therefore, the channel card may be a third type of channel card. Refer to FIG. 2A for additional details regarding types of channel cards.

Therefore, channel card type 224 may identify the channel card as the first type, the second type, the third type of channel cards, and/or another type. While described herein as including three types of channel cards, any number of types of channel cards may be included in the schema and assigned to channel cards without departing from embodiments disclosed herein.

Channel card type 224 may be utilized by the management controller to perform level of trust assignment process 228 to assign a level of trust to the channel card and obtain level of trust 230. During level of trust assignment process 228, the management controller may compare channel card type 224 to schema 226. Schema 226 may include a rule set, table, and/or other information usable to associate levels of trust with types of channel cards. For example, schema 226 may include mappings indicating: (i) the first type of channel card is to be assigned a level of trust of 1, (ii) the second type of channel card is to be assigned a level of trust of 2, and/or (iii) the third type of channel card is to be assigned a level of trust of 3. While described herein as including three levels of trust, any number of levels of trust may be assigned to types of channel cards based on the types of channel cards and/or based on other criteria without departing from embodiments disclosed herein.

Level of trust 230 may include the assigned level of trust for the channel card (e.g., 1, 2, 3) and/or other information. The other information may include an identifier for the channel card (e.g., from channel card identifier 220), a definition associated with the level of trust (e.g., indicating permissions allowed for the channel card, etc.

Level of trust 230 may be used to populate channel card trust table 204. For example, the channel card added to the data processing system may be channel card C and level of trust 230 may indicate that channel card C is to be assigned a level of trust of 3. The channel card identifier of “channel card C” and the level of trust of “3” may be added to channel card trust table 204 by the management controller.

Channel card trust table 204 may be provided by the management controller and via a sideband channel of the data processing system, to a BIOS of the data processing system. The BIOS of the data processing system may include firmware that manages startup procedures for the data processing system. For example, the BIOS may publish channel card trust table 204 during the startup procedure to make channel card trust table 204 available to an operating system of the data processing system. The operating system may then utilize channel card trust table 204 during operation of the data processing system as described in FIG. 2A.

Thus, using the data flows shown in FIGS. 2A-2B, channel cards added to the data processing system may be assigned levels of trust by the management controller, the management controller being separate from the hardware resources and tasked with managing the hardware resources. Therefore, in the event that the hardware resources are compromised by a malicious entity, the malicious entity may not be able to modify and/or access the levels of trust for the channel cards. Consequently, the channel card trust table may be made available to the hardware resources during startup but may not be modifiable by any potentially compromised hardware resources (and/or hosted software entities).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1B may perform various methods to manage operation of a data processing system. FIGS. 3A-3B illustrate methods that may be performed by the components of FIGS. 1A-1B. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method in accordance with an embodiment is shown. The flow diagram may illustrate various operations performed while managing interactions between channel cards and hardware components of hardware resources of the data processing system. The data processing system may include hardware resources (including any number of channel cards) and a management controller, and may be similar to the data processing system discussed with respect to FIGS. 1A-1B.

At operation 300, an identification may be made that a channel card of a data processing system has (and/or is in the process of and/or may in the future) attempted an interaction with a hardware component of hardware resources of the data processing system. Making the identification may include: (i) snooping communication channels (e.g., in-band channels) of the data processing system and identifying attempted communications traversing the communication channels from the channel cards, (ii) intercepting the attempted communications, and/or (iii) other methods. The intercepted communications may include an identifier for the channel card that provided the communication, an identifier for the hardware component (e.g., the intended recipient), and/or other information.

At operation 302, a level of trust for the channel card may be obtained using a channel card trust table and in response to the identification. Obtaining the level of trust may include: (i) obtaining an identifier for the channel card attempting to communicate with the hardware component (e.g., from the intercepted communication), (ii) performing a lookup process using the identifier for the channel card as a key for the channel card trust table (e.g., a lookup table), and/or (iii) obtaining, as a result of the lookup process and from the channel card trust table, a level of trust that corresponds to the identifier for the channel card.

At operation 304, it may be determined whether the channel card is authorized to interact with the hardware component based on the level of trust. Making the determination may include: (i) obtaining a definition for the level of trust (e.g., a list of authorized actions, a list of hardware components authorized for access) from the channel card trust table and/or from storage, (ii) comparing the identifier for the intended recipient of the attempted communication (e.g., the hardware component) to the definition of the level of trust to determine whether the hardware component is an authorized hardware component, and/or (iii) other methods. Making the determination may also include providing the level of trust to another entity responsible for consulting the definition of the level of trust.

If the channel card is authorized to interact with the hardware component, the method may proceed to operation 306.

At operation 306, the attempted interaction may be allowed to occur. Allowing the attempted interaction to occur may include: (i) allowing the attempted communication to reach the hardware component (e.g., forwarding the attempted communication, releasing a hold on the attempted communication, etc.), (ii) notifying the channel card that the attempted communication is authorized, (iii) notifying the hardware component that the communication is authorized, and/or (iv) other methods.

The method may end following operation 306.

Returning to operation 304, the method may proceed to operation 308 if the channel card is not authorized to interact with the hardware component.

At operation 308, the attempted interaction may be denied. Denying the attempted interaction may include: (i) deleting and/or returning the attempted communication thereby disallowing the attempted communication to reach the hardware component, (ii) notifying the channel card that the attempted communication is not authorized, (iii) writing a log entry related to the attempted communication in storage, and/or (iv) other methods.

While described with respect to active interception, it will be appreciated that proactive prevention of attempts to interact may be used. For example, device visibility to a channel card may be proactively limited based on the level of trust for the channel card. In this manner, the attempts to interact may be proactively limited by prevent the channel card from being aware of the existence some other hardware components.

The method may end following operation 308.

The attempted interaction may facilitate provisioning of a computer-implemented service when authorized and, therefore, monitoring attempted communications from channel cards to hardware components may increase a likelihood of providing the computer-implemented service as desired. By denying interactions that are not authorized, potentially compromised channel cards may have a reduced likelihood of compromising hardware components of the data processing system thereby increasing a quality and/or reliability of the computer-implemented services provided.

Turning to FIG. 3B, a second flow diagram illustrating a method in accordance with an embodiment is shown. The second flow diagram may illustrate various operations performed while assigning levels of trust for channel cards of a data processing system. The data processing system may include hardware resources (including any number of channel cards) and a management controller, and may be similar to the data processing system discussed with respect to FIGS. 1A-1B.

At operation 310, a channel card of the data processing system may be typified to obtain a type of the channel card. Typifying the channel card may include: (i) obtaining identifying information for the channel card (e.g., a manufacturer, a serial number) from the channel card and/or from another entity, (ii) comparing the identifying information to a schema for assigning types of channel cards, (iii) obtaining, using the schema, the type of the channel card, and/or (iv) other methods.

At operation 312, a level of trust for the channel card may be assigned based on the type of the channel card and a schema for assigning levels of trust. Assigning the level of trust may include performing a lookup process using the type of the channel card as a key for a level of trust lookup table (e.g., indicated by the schema) and obtaining the level of trust as a result of the lookup process and/or other methods. Refer to FIG. 2B for additional details regarding identifying types of channel cards and assigning levels of trust based on the types of the channel cards.

At operation 314, a channel card trust table may be populated using the level of trust. The channel card trust table may indicate levels of trust for each channel card of the data processing system. Populating the channel card trust table may include: (i) adding (e.g., writing) an identifier for the channel card and the level of trust for the channel card to the channel card trust table, (ii) providing the identifier for the channel card and the level of trust to another entity responsible for modifying the channel card trust table, and/or (iii) other methods.

At operation 316, the channel card trust table may be provided to a BIOS of the data processing system. Providing the channel card trust table to the BIOS may include: (i) encapsulating the channel card trust table in a message, (ii) transmitting the message across a sideband channel of the data processing system to the BIOS, (iii) storing the channel card trust table in storage and providing the BIOS with instructions to retrieve the channel card trust table, and/or (iv) other methods.

At operation 318, the channel card trust table may be published during a startup procedure for the data processing system so that the channel card trust table is usable by an operating system of the data processing system during operation of the data processing system. Publishing the channel card trust table may include: (i) storing the channel card trust table in a storage architecture accessible by the operating system but not editable by the operating system, (ii) notifying the operating system that the channel card trust table is available (e.g., providing instructions for the operating system to utilize the channel card trust table to manage interactions between channel cards and hardware components), (iii) initiating the startup procedure for the data processing system, and/or (iv) other methods.

The method may end following operation 318.

Thus, channel cards added to the data processing system may be identified and levels of trust may be assigned prior to allowing the channel cards to access hardware resources during operation of the data processing system. By doing so, potentially compromised channel cards may have a reduced likelihood of compromising the hardware components and the computer-implemented services provided by the hardware resources may have an increased likelihood of being provided as desired.

Any of the components illustrated in FIGS. 1A-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a BIOS as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
making an identification that a channel card of the data processing system has attempted an interaction with a hardware component of hardware resources of the data processing system;
in response to the identification:
obtaining, using a channel card trust table, a level of trust for the channel card, the level of trust being based, at least in part, on a type of the channel card;
making a determination, based on the level of trust, regarding whether the channel card is authorized to interact with the hardware component;
in a first instance of the determination in which the channel card is authorized to interact with the hardware component:
allowing the attempted interaction to occur, wherein the interaction facilitates provisioning of a computer implemented service; and
in a second instance of the determination in which the channel card is not authorized to interact with the hardware component:
denying the attempted interaction.

2. The method of claim 1, further comprising:
prior to making the identification:
typifying, by a management controller of the data processing system, the channel card to obtain the type of the channel card;
assigning, by the management controller and based on the type of the channel card and a schema for assigning levels of trust, the level of trust for the channel card;
populating, by the management controller and using the level of trust, the channel card trust table, the channel card trust table indicating levels of trust for each channel card of the data processing system;
providing, by the management controller, the channel card trust table to a basic input/output system (BIOS) of the data processing system; and
publishing, by the BIOS, the channel card trust table during a startup procedure for the data processing system so that the channel card trust table is usable by an operating system of the data processing system during operation of the data processing system.

3. The method of claim 1, wherein the type of the channel card comprises one selected from a list consisting of:
a first type of channel card that is constructed by a manufacturer of the data processing system;
a second type of channel card that authorized by the manufacturer but is not constructed by the manufacturer; and
a third type of channel card that is not authorized by the manufacturer.

4. The method of claim 3, wherein the channel card trust table comprises a list of channel cards of the data processing system and levels of trust for each channel card of the list of the channel cards, the levels of trust indicating different degrees of authorization for accessing the hardware resources, and the channel card being one of the channel cards.

5. The method of claim 4, wherein the levels of trust for each channel card of the list of channel cards are based on associations between different types of channel cards and different levels of trust.

6. The method of claim 4, wherein the first type of channel card has a higher degree of authorization for accessing the hardware resources than the second type of the channel card.

7. The method of claim 6, wherein the first type of channel card has a first degree of authorization for accessing the hardware resources that allows activation of all functions of the hardware resources, the second type of channel card has a second degree of authorization for accessing the hardware resources that allows activation of a portion of functions of a portion of the hardware resources, and the third type of channel card has a third degree of authorization for accessing the hardware resources that allows no activation of functions of the hardware resources.

8. The method of claim 3, wherein the levels of trust are assigned by a management controller of the data processing system and provided, by the management controller, to a basic input/output system (BIOS) of the data processing system prior to a startup procedure for the data processing system.

9. The method of claim 2, wherein the data processing system comprises the management controller separate from and tasked with managing operation of the hardware resources and the channel cards.

10. A non-transitory machine-readable medium having instructions stored therein, which when executed by a processor, cause the processor to perform operations for managing operation of a data processing system, the operations comprising:
making an identification that a channel card of the data processing system has attempted an interaction with a hardware component of hardware resources of the data processing system;
in response to the identification:
obtaining, using a channel card trust table, a level of trust for the channel card, the level of trust being based, at least in part, on a type of the channel card;
making a determination, based on the level of trust, regarding whether the channel card is authorized to interact with the hardware component;
in a first instance of the determination in which the channel card is authorized to interact with the hardware component:
allowing the attempted interaction to occur, wherein the interaction facilitates provisioning of a computer implemented service; and
in a second instance of the determination in which the channel card is not authorized to interact with the hardware component:
denying the attempted interaction.

11. The non-transitory machine-readable medium of claim 10, wherein the operations further comprise:
prior to making the identification:
typifying, by a management controller of the data processing system, the channel card to obtain the type of the channel card;
assigning, by the management controller and based on the type of the channel card and a schema for assigning levels of trust, the level of trust for the channel card;
populating, by the management controller and using the level of trust, the channel card trust table, the channel card trust table indicating levels of trust for each channel card of the data processing system;
providing, by the management controller, the channel card trust table to a basic input/output system (BIOS) of the data processing system; and
publishing, by the BIOS, the channel card trust table during a startup procedure for the data processing system so that the channel card trust table is usable by an operating system of the data processing system during operation of the data processing system.

12. The non-transitory machine-readable medium of claim 10, wherein the type of the channel card comprises one selected from a list consisting of:
a first type of channel card that is constructed by a manufacturer of the data processing system;
a second type of channel card that authorized by the manufacturer but is not constructed by the manufacturer; and
a third type of channel card that is not authorized by the manufacturer.

13. The non-transitory machine-readable medium of claim 12, wherein the channel card trust table comprises a list of channel cards of the data processing system and levels of trust for each channel card of the list of the channel cards, the levels of trust indicating different degrees of authorization for accessing the hardware resources, and the channel card being one of the channel cards.

14. The non-transitory machine-readable medium of claim 13, wherein the levels of trust for each channel card of the list of channel cards are based on associations between different types of channel cards and different levels of trust.

15. The non-transitory machine-readable medium of claim 13, wherein the first type of channel card has a higher degree of authorization for accessing the hardware resources than the second type of the channel card.

16. A data processing system, comprising:
a processor; and
a memory coupled to the processor to store instructions, which when executed by the processor, cause the processor to perform operations, the operations comprising:
making an identification that a channel card of the data processing system has attempted an interaction with a hardware component of hardware resources of the data processing system;
in response to the identification:
obtaining, using a channel card trust table, a level of trust for the channel card, the level of trust being based, at least in part, on a type of the channel card;
making a determination, based on the level of trust, regarding whether the channel card is authorized to interact with the hardware component;
in a first instance of the determination in which the channel card is authorized to interact with the hardware component:
allowing the attempted interaction to occur, wherein the interaction facilitates provisioning of a computer implemented service; and
in a second instance of the determination in which the channel card is not authorized to interact with the hardware component:
denying the attempted interaction.

17. The data processing system of claim 16, wherein the operations further comprise:
prior to making the identification:
typifying, by a management controller of the data processing system, the channel card to obtain the type of the channel card;
assigning, by the management controller and based on the type of the channel card and a schema for assigning levels of trust, the level of trust for the channel card;
populating, by the management controller and using the level of trust, the channel card trust table, the channel card trust table indicating levels of trust for each channel card of the data processing system;
providing, by the management controller, the channel card trust table to a basic input/output system (BIOS) of the data processing system; and
publishing, by the BIOS, the channel card trust table during a startup procedure for the data processing system so that the channel card trust table is usable by an operating system of the data processing system during operation of the data processing system.

18. The data processing system of claim 16, wherein the type of the channel card comprises one selected from a list consisting of:
a first type of channel card that is constructed by a manufacturer of the data processing system;
a second type of channel card that authorized by the manufacturer but is not constructed by the manufacturer; and
a third type of channel card that is not authorized by the manufacturer.

19. The data processing system of claim 18, wherein the channel card trust table comprises a list of channel cards of the data processing system and levels of trust for each channel card of the list of the channel cards, the levels of trust indicating different degrees of authorization for accessing the hardware resources, and the channel card being one of the channel cards.

20. The data processing system of claim 19, wherein the levels of trust for each channel card of the list of channel cards are based on associations between different types of channel cards and different levels of trust.
